(19) United States
(12) Patent Application Publication
(10) Pub. No.: US 2015/0006642 A1
(43) Pub. Date: Jan. 1, 2015

(54) METHOD AND TECHNICAL EQUIPMENT FOR AUTOMATIC NOTIFICATION GENERATION

(71) Applicant: M-Files Oy, Tampere (FI)

(72) Inventors: Hannu Viitala, Tampere (FI); Antti Nivala, Pirkkala (FI)

(21) Appl. No.: 13/927,622

(22) Filed: Jun. 26, 2013

(51) Int. Cl. H04L 12/58

(52) U.S. Cl. CPC H04L 51/02
USPC 709/206

(57) ABSTRACT

The invention relates to a method, comprising detecting a notifiable operation concerning an electronic object; automatically generating a notification relating to the detected operation; wherein the generating comprises creating the notification at least from data that is a metadata value of such electronic object that is a target of an indirect reference chain, which chain starts from the electronic object in question sending electronically the generated notification to a relevant user. The invention relates also to an apparatus and a computer program product. The invention may be utilized in a document management system.

### TECHNICAL FIELD

The present application relates to a method, an apparatus and a computer program product for automatic notification generation.

### BACKGROUND

Electronic messaging (e.g. emailing, short messaging, instant messaging) has become one of the most used communication methods of today. Typically electronic messaging comprises creating a message manually by inputting text into a message, defining to whom the message is to be sent and then sending the message to the recipient. The recipient's contact information depends on the communication method, for example an email address is typically formed of local part and domain part being separated by the “@”-sign and a short messaging is targeted to the recipient's telephone number.

In addition to manual generation of messages, electronic messages can be generated automatically. A well-known example of an automatic message is an out-of-office automatic reply message which is generated as a response to a received message when the recipient is out-of-office. Such an automatic message can be pre-defined by a user. In some cases also a messaging system can generate automatic messages—for example when a recipient address cannot be solved (resolved) and the message cannot be transmitted.

Today's data management systems and/or data workflow systems are also able to generate automatic messages (i.e. notifications) on actions performed in the system. For example, when a certain state has been reached (i.e. certain action has been finished) in the workflow, a relevant user is notified of that with an automatically generated notification. The message may have a system specific template, which is completed with relevant information, e.g. file name, user data and occurred action. However, known systems are only able to use such information that is directly obtainable from the file in question. There is, therefore, a need for a solution that expands the automatic generation of notifications in such a manner that also data that is not directly related to the file can be used as content of the notification.

### SUMMARY OF THE INVENTION

Now there has been invented an improved method and technical equipment implementing the method, to address such a need. Various aspects of the invention include a method, an apparatus and a computer readable medium comprising a computer program stored therein, which are characterized by what is stated in the independent claims. Various embodiments of the invention are disclosed in the dependent claims.

According to a first aspect a method comprises detecting a notifiable operation concerning an electronic object; automatically generating a notification relating to the detected operation; wherein the generating comprises creating the notification at least from data that is a metadata value of such electronic object that is a target of an indirect reference chain, which chain starts from the electronic object in question; and sending electronically the generated notification to a relevant user.

According to a second aspect, an apparatus comprises at least one processor, memory including computer program code, the memory and the computer program code configured to, with the at least one processor, cause the apparatus to perform at least the following: detecting a notifiable operation concerning an electronic object; automatically generating a notification relating to the detected operation; wherein the generating comprises creating the notification at least from data that is a metadata value of such electronic object that is a target of an indirect reference chain, which chain starts from the electronic object in question; and sending electronically the generated notification to a relevant user.

According to a third aspect, a computer program product embodied on a non-transitory computer readable medium, comprises computer program code configured to, when executed on at least one processor, cause an apparatus or a system to: detect a notifiable operation concerning an electronic object; automatically generate a notification relating to the detected operation; wherein the generating comprises creating the notification at least from data that is a metadata value of such electronic object that is a target of an indirect reference chain, which chain starts from the electronic object in question, send electronically the generated notification to a relevant user.

According to an embodiment, the notifiable operation is an operation that needs to be informed to the relevant user in order to keep the object in process.

According to an embodiment, the notifiable operation is one of the following: a new object in a workflow, a state transition of an object, and a new assignment concerning the object.

According to an embodiment, the relevant user is determined from the metadata of the electronic object.

According to an embodiment, the relevant user is determined from the metadata of such electronic object that is a target of an indirect reference chain, which chain starts from the electronic object in question.

According to an embodiment, the relevant user is pre-defined for the notifiable operation.

According to an embodiment, the notification is sent by means of following methods: email, short messaging, instant messaging, an electronic assignment.

According to an embodiment, the method is carried out in a document management system.

### DESCRIPTION OF THE DRAWINGS

In the following, various embodiments of the invention will be described in more detail with reference to the appended drawings, in which

FIG. 1 shows a simplified example of a system configuration;

FIG. 2 shows an example of an electronic object having a state transition;

FIG. 3 shows an example of a notification being automatically generated of data that is directly related to the object;

FIG. 4 shows an example of a chain of references between electronic objects;

FIG. 5 shows an example of a notification according to an embodiment;

FIG. 6 shows an example of an apparatus according to an embodiment; and

FIG. 7 shows an example of a method according to an embodiment.

### DESCRIPTION OF EXAMPLE EMBODIMENTS

In the following, several embodiments of the invention will be described in the context of document management system, i.e. generating and transmitting notifications in/from a document management system. Parallel terms for document management system are “content management system”, “data management system”, “enterprise content management system”. An example of a document management system is M-files® document management system. It is to be noted, however, that the invention is not limited to the document management system. In fact, the different embodiments have applications in any environment where automatic generation and transmission of notifications is required.

The document management system (DMS) refers to a file arrangement that stores objects being defined by metadata (i.e. properties). Such a system comprises various features for managing electronic documents, e.g. storing, versioning, indexing, searching for and retrieval of documents. It is appreciated that there are both dynamic and static document management systems. The difference between dynamic and static systems is the way they store files. In the static systems files are stored e.g. in a constant treelike hierarchy that defines relationships for folders and documents stored in the tree. In the dynamic systems the files may be given identifications that define their existence in the system. The observed location of the files is not constant, but may vary in a virtual space depending on the situation.

In this disclosure, the term “document” relates to a medium (a file) that has been created by a certain application and that has been associated with metadata. For example, a piece of text created by using the Microsoft Word application is a file. “Metadata” refers to information on a document's properties. For example, a creator of the file or a creation date may represent the metadata. The term “object”/“electronic object” refers to a document, and is composed of the content of the object as well as of the metadata of the object. Documents and other metadata defined objects are located statically or virtually in the file arrangement. Virtual location is defined by giving a document location(s) based on its metadata, which then addresses the document into a certain virtual folder depending on the route the document is approached. Therefore the content of each folder depends on the current property values of objects and may vary according to a use case and is thus dynamic.

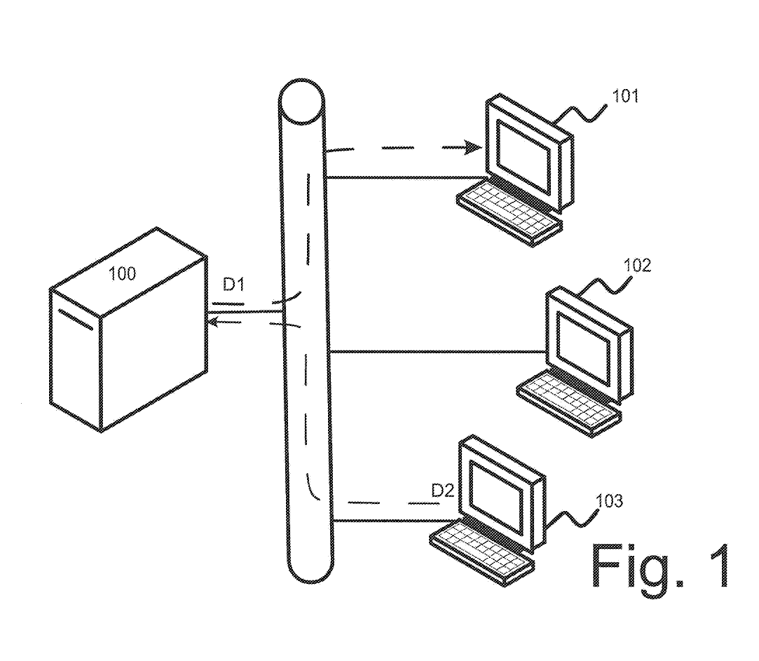

An example of a system configuration is illustrated in FIG. 1. This system configuration is a document management system that comprises a document management server 100 and client devices 101, 102, 103, which are interconnected. The interconnection can be wired or wireless and it may be substantially always on or it may be disconnected occasionally. The server 100 is configured to store objects (e.g. documents) that can be retrieved by the client devices 101, 102, 103. The server and client devices each typically includes at least one processor and at least one memory (computer readable medium) for storage of at least computer program code for execution by the at least one processor. The client device can be any electronic device capable of computing, such as e.g. a personal computer, a laptop, a mobile device. Instead of the server 100, the document management system may comprise more than one servers, and at least one of these servers may be cloud-based server while the others are so called “on-premise servers”.

As an example, in FIG. 1 document D1 is retrieved by client device 101, whereas document D2 is stored by the client device 103 to the document management server 100. The document management server 100 is configured mainly to store documents, but in use the document management server may have other functions as well, e.g. it controls access rights, registers modifications made to documents and allows connections to other systems. An electronic document stored in the document management system is an example of an object. Such an object is given metadata items (i.e. property values) e.g. a name of creator, a type of a document, a project which the document belongs to, a security class, a client etc.

As was mentioned, the document management system can be dynamic so that the folders are virtual, and the documents are virtually located in the folders depending on the user's viewpoint that builds on top of metadata. Documents can have more than one location in the dynamic document management system but the document as such is the same document throughout the locations. In other words, the document is stored into the document management system only once, but is given multiple locations based on its metadata items. The present embodiments can also be utilized in a file management system statically storing folders that comprises files Therefore, term “location” should be interpreted as both a physical and virtual location depending on the file arrangement to cover both dynamic document management system and file management system. However, in order to utilize the present solution, the objects (e.g. documents, folders) have to be associated with metadata. This means that each e.g. document has a property structure defining at least one piece of metadata (i.e. metadata item) for the document.

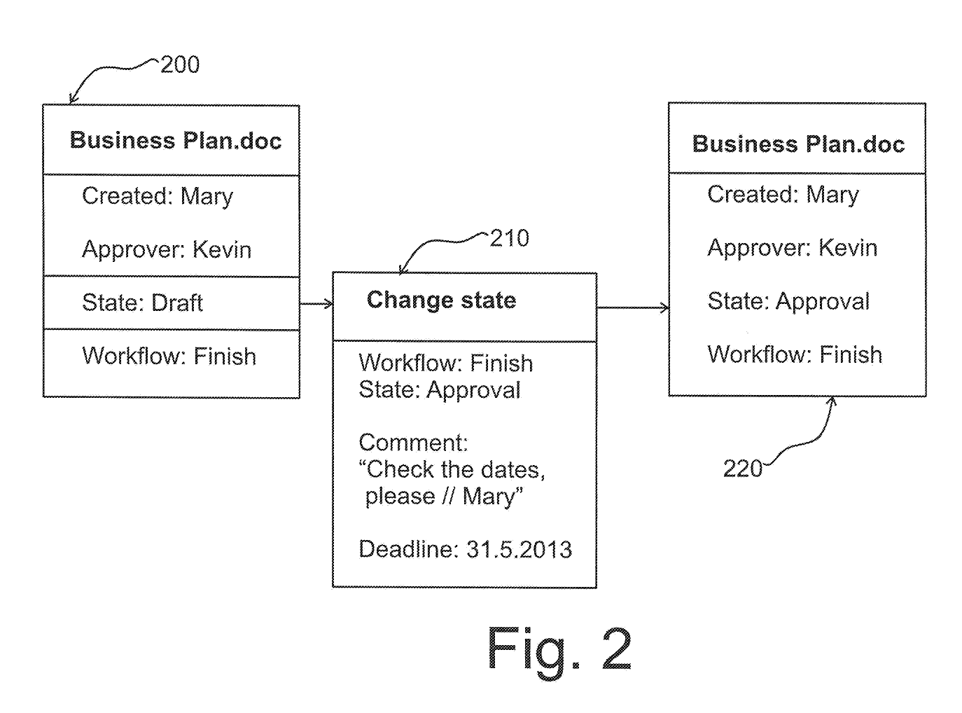

FIG. 2 illustrates an electronic object 200 called “Business Plan.doc” (later referred as “Business Plan”) and being defined with metadata “Created: Mary; Approver: Kevin; State: Draft; Workflow: Finish”, where “Created”; “Approver”; “State”; “Workflow” represent metadata's definition part (i.e. property definition), and “Mary”; “Kevin”; “Draft”; “Finish” represent metadata values respectively.

According to an embodiment, the state of the electronic object 200 can be changed via view 210, where state transition e.g. from “Draft” to “Approval” is performed. The user making the state transition can comment the state transition “Check the dates, please II Mary” and create a deadline for the operation, e.g. “31.5.2013”. After the state transition, the object “Business Plan” has metadata 220, where property definition “State” has a property value “Approval”.

Due to the state transition, a notification is automatically created, by means of which the user being assigned to do the approval is notified on the new state. It is realized from the metadata of the electronic object 200 that the approver is “Kevin”. The notification is thus sent to Kevin according to the contact information relating to Kevin and being stored in the system.

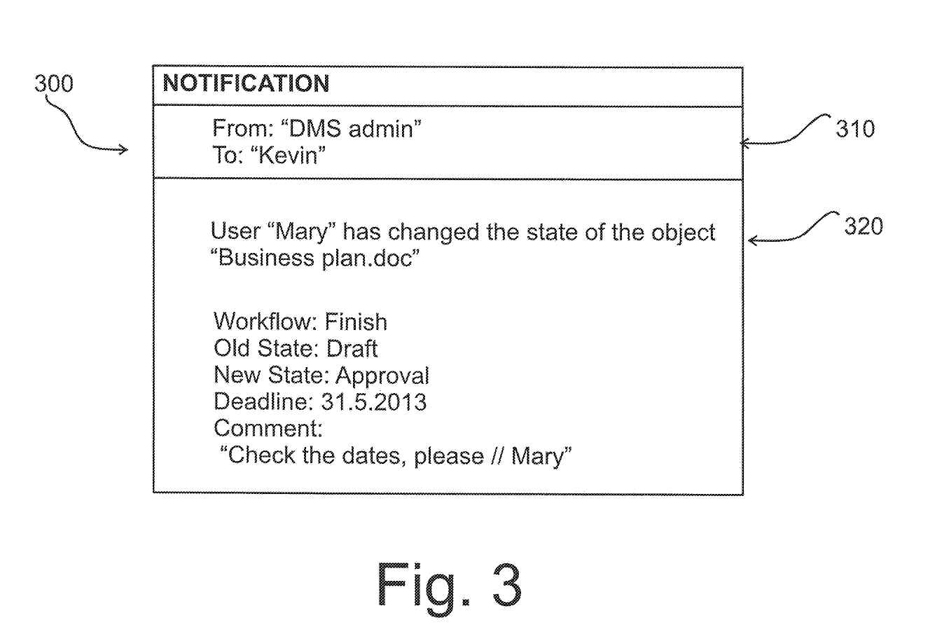

FIG. 3 is an example of the notification 300. As said, the notification is automatically generated by the document management system after the state transition. In this example, the sender of the notification 300 is marked to be “DMS admin”, because the notification is sent from the document management system. However, in some other examples, the sender can be e.g. the user “Mary”. The content of the notification 300 is shown with reference 320. The template of the notification contains fields, i.e. placeholders, that are named as “Workflow”; “Old State”; “New State”; “Deadline”; “Comment”. The placeholders are filled during the automatic notification generation with property values concerning the electronic object “Business Plan”, i.e. “Finish”; “Draft”; “Approval”; “31.5.2013”; “Check the dates, please//Mary” respectively. Thus, term “placeholder” defines a fill-in field in a message (i.e. a notification) template that is filled automatically with data obtained from a metadata of an electronic object in question. It is appreciated that the content of the placeholder varies depending on the electronic object, on the property values, on the state etc.

The notification may be sent to “Kevin” by means of an email or any other electronic messaging system (e.g. short messaging service, instant message).

According to an embodiment of the present invention, the placeholders may be also be filled with data that is not directly obtained from a metadata of the electronic object in question (as in the examples of FIG. 3) but the data inserted to the placeholders is obtained from a metadata that is indirectly related to the electronic object.

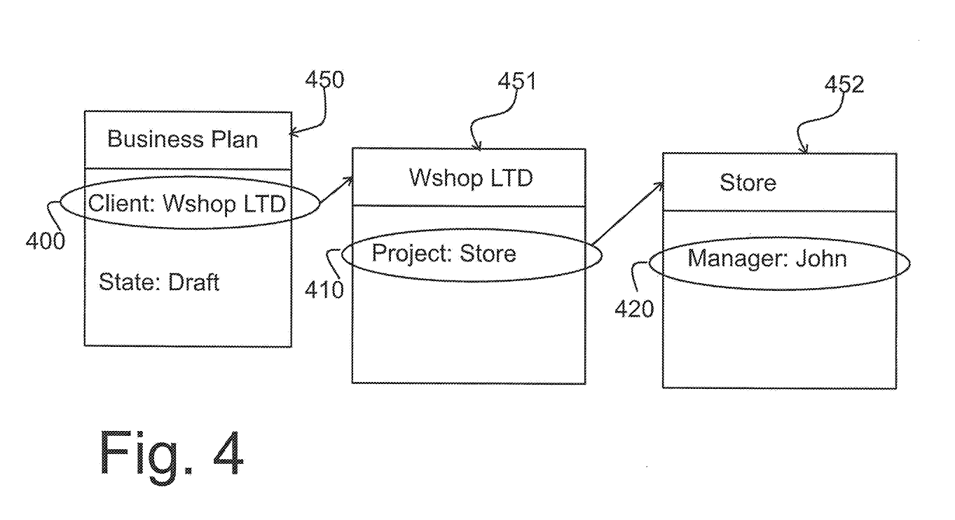

Yet in other words, the data to be put to the placeholders is obtained from metadata of an object that is referred by metadata of the object. To put it more precisely, the data for the placeholder is a value of a metadata of an object that is referred by a value of a metadata of the object in question (e.g. “Business plan”). It is appreciated that the chain of references can be longer than in the previous example, i.e. a value of a metadata of an object referred by a value of a metadata of an object referred by a value of a metadata of an object referred by a value of the object in question. This is illustrated by means of an example in FIG. 4. Electronic object “Business Plan” 450 has a metadata “Client” having value “Wshop LTD” 400. This metadata value “Wshop LTD” acts as a reference to an electronic object “Wshop LTD” 451 having metadata “Project” with value “Store” 410. Again, the metadata value “Store” acts as a reference to an electronic object “Store” 452, having metadata “Manager” with value “John”.

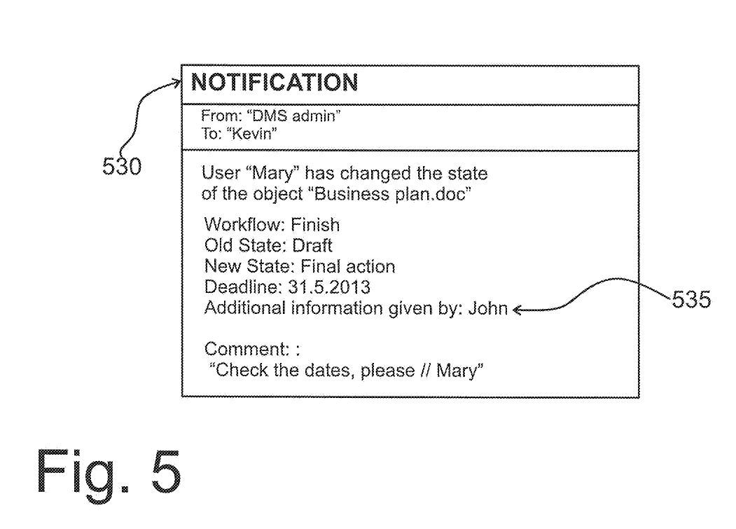

When a state of the electronic object “Business Plan” 450 is changed from “Draft” to “Final action”, the property value “John” in electronic object “Store” 452 can be automatically obtained to the generated notification concerning the state transition of “Business Plan” 450, e.g. to a placeholder “Additional information is given by “John””, where “John” is an indirect fill-in data to the placeholder. FIG. 5 illustrates a notification 530 according to an embodiment, wherein the notification 530 has a placeholder 535 having indirectly related content.

To enable indirect obtaining of metadata values, the document management system's notification generation is configured as follows: At first a notification template is obtained. The notification template may have a template text and place-holders for variables, i.e. for fill-in data. There can be several notification templates, each having different template text, e.g. a notification template for each state transition in a workflow. The template text and placeholders may be defined by an administrator through an administrator user interface. The place holders may be defined with a dot-notation. According to examples shown in FIGS. 4 and 5, in a notification template for notification 530, the template text may be as follows:
User [placeholder] has changed the state of the object [placeholder].
Workflow: [placeholder]
Old state: [placeholder]
New State: [placeholder]
Deadline: [placeholder]
Additional information given by: [placeholder]
Comment [placeholder]

Yet further, for defining the content for the placeholders, the notification template is as follows:
User [.user] has changed the state of the object [.title].
Workflow: [.workflow]
Old state: [.old state]
New State: [.new state]
Deadline: [.deadline]
Additional information given by: [client.project.manager]
Comment [.comment]
   where “.user”, “.title”, “.workflow”, “.old state”, “.new state”, “.deadline” and “.comment” are direct metadata values of the document “Business Plan.doc” taken from corresponding metadata items. However, “client.project.manager” defines an indirect metadata value, that is to be included into the notification. As shown in FIG. 4, the indirect metadata value is “John”, because client-project-manager metadata value chain being started from a document in question, i.e. Business Plan.doc, ends up to a value “John”.

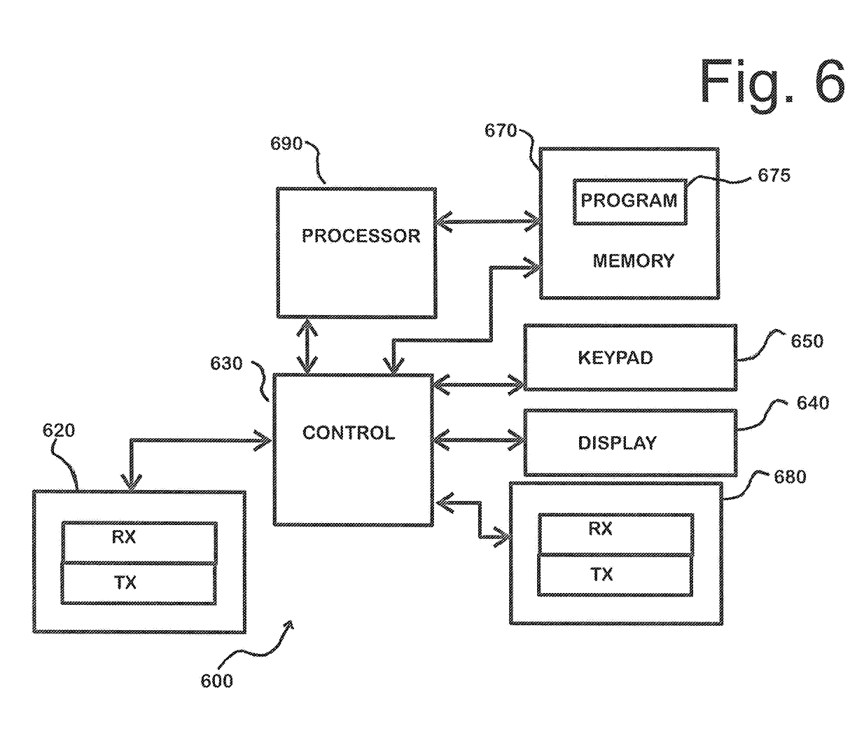

FIG. 6 illustrates an example of an apparatus 600, e.g. a server. The apparatus 600 comprises a processor 690 (Central Processing Unit, CPU) for processing data and a memory 670 that may store applications and various data etc. The server also comprises computer program code 675 residing in the memory 670. The memory 670 may be, but is not limited to, a single memory, CD, DVD, ROM, RAM, EEPROM, optical storage, or any other non-volatile storage medium capable of storing digital data.

The apparatus 600 comprises also a control unit 630 for controlling functions in the apparatus 600. The control unit 630 (MCU, Main Control Unit) may comprise one or more processors. The control unit 630 may run a user interface software to facilitate user control of at least some functions of the apparatus 600. The control unit 630 may also deliver a display command and a switch command to a display 640 to display visual information, e.g. a user interface.

The apparatus may also be connected to a keypad 650 for receiving input from the user. The control unit 630 may also communicate with the processor 690 and can access the memory 670. Yet further, the server may comprise various communication means 620, 680 having a transmitter and a receiver for connecting to the network and for sending and receiving information. The first communicating means 620 can be adapted for telecommunication and the other communicating means 680 can be a one kind of short-range communicating means, such as Bluetooth™ system, WLAN system (Wireless Local Area Network) or other system which suits for local use and for communicating with another device.

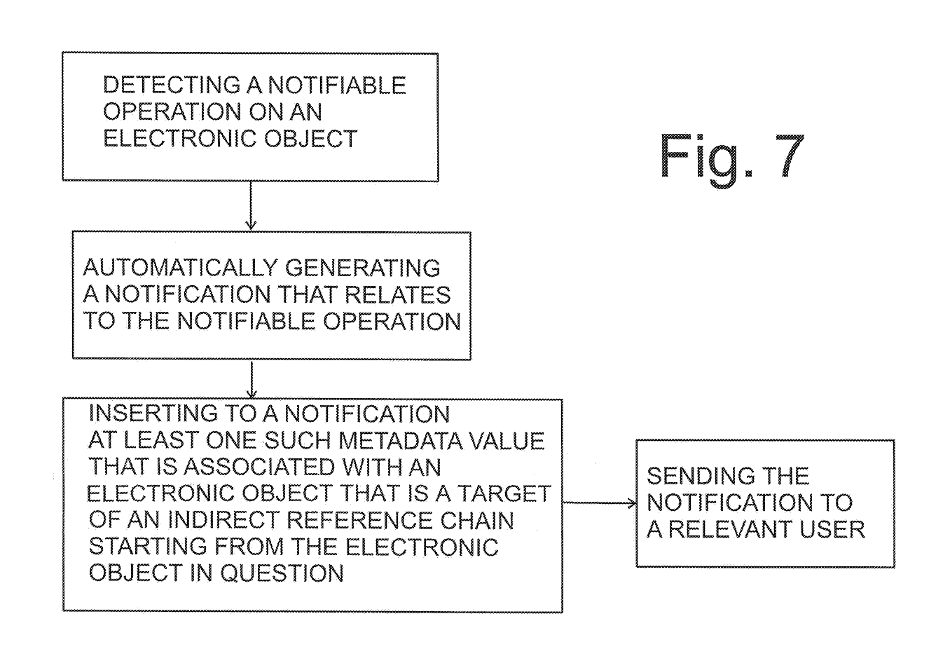

An example of a method is illustrated with simplified flowchart in FIG. 7. At first a notifiable operation concerning an electronic object is detected. A notifiable operation is such that it needs to be informed to relevant users in order to keep the object in process. Examples of a notifiable operations are a new object in a workflow, a state transition of an object, a new assignment concerning the object, check-out of a document, check-in of a document, undo a modification, finishing an asynchronic downloading of a file, a certain time from a certain operation has elapsed, change of a referenced-to file of a document, etc. It is thus appreciated that any situation, where automatic notifications can be generated could be provided as an example. Once the notifiable operation has been detected, the system is configured to automatically generate a notification that relates to the detected operation. In the automatic notification generation, a notification template is completed with data that is obtained from a metadata of an/the electronic object. The data can be obtained by means of e.g. dot-notation being used in the placeholders. At least one piece of such data is a metadata value that is associated with an electronic object that is a target of an indirect reference chain, which chain starts from the electronic object in question (see the example of FIG. 4).

The various embodiments of the invention can be implemented with the help of computer program code that resides in a memory and causes the relevant apparatuses to carry out the invention. For example, a client device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

What is claimed is:

1. A method, comprising:
detecting a notifiable operation concerning an electronic object;
automatically generating a notification relating to the detected operation; wherein the generating comprises
creating the notification at least from data that is a metadata value of such electronic object that is a target of an indirect reference chain, which chain starts from the electronic object in question; and
sending electronically the generated notification to a relevant user.

2. The method according to claim 1, wherein the notifiable operation is an operation that needs to be informed to the relevant user in order to keep the object in process.

3. The method according to claim 1, wherein the notifiable operation is one of the following: a new object in a workflow, a state transition of an object, and a new assignment concerning the object.

4. The method according to claim 1, wherein the relevant user is determined from the metadata of the electronic object.

5. The method according to claim 1, wherein the relevant user is determined from the metadata of such electronic object that is a target of an indirect reference chain, which chain starts from the electronic object in question.

6. The method according to claim 1, wherein the relevant user is pre-defined for the notifiable operation.

7. The method according to claim 1, comprises transmitting the notification by means of any of the following methods: email, short messaging, instant messaging, and an electronic assignment.

8. The method according to claim 1, being carried out in a document management system.

9. An apparatus comprising at least one processor, memory including computer program code, the memory and the computer program code configured to, with the at least one processor, cause the apparatus to perform at least the following:
detecting a notifiable operation concerning an electronic object;
automatically generating a notification relating to the detected operation; wherein the generating comprises
creating the notification at least from data that is a metadata value of such electronic object that is a target of an indirect reference chain, which chain starts from the electronic object in question; and
sending electronically the generated notification to a relevant user.

10. The apparatus according to claim 9, wherein the notifiable operation is an operation that needs to be informed to the relevant user in order to keep the object in process.

11. The apparatus according to claim 9, wherein the notifiable operation is one of the following: a new object in a workflow, a state transition of an object, and a new assignment concerning the object.

12. The apparatus according to claim 9, wherein the relevant user is determined from the metadata of the electronic object.

13. The apparatus according to claim 9, wherein the relevant user is determined from the metadata of such electronic object that is target of an indirect reference chain, which chain starts from the electronic object in question.

14. The apparatus according to claim 9, wherein the relevant user is pre-defined for the notifiable operation.

15. The apparatus according to claim 9, further comprising code configured to cause the apparatus to perform:
sending the notification by means of any of the following methods: email, short messaging, instant messaging, and an electronic assignment.

16. The apparatus according to claim 9, comprising a document management system.

17. A computer program product embodied on a non-transitory computer readable medium, comprising computer program code configured to, when executed on at least one processor, cause an apparatus or a system to:
detect a notifiable operation concerning an electronic object;
automatically generate a notification relating to the detected operation; wherein the generating comprises
creating the notification at least from data that is a metadata value of such electronic object that is a target of an indirect reference chain, which chain starts from the electronic object in question; and
send electronically the generated notification to a relevant user.
